(19) United States
(12) Patent Application Publication
(10) Pub. No.: US 2016/0129407 A1
(43) Pub. Date: May 12, 2016

(54) ACCELERATION OF ALCOHOL AGING AND/OR LIQUID MIXING/MATURATION USING REMOTELY POWERED ELECTROMECHANICAL AGITATION

(71) Applicants: Matthew Brett Wrosch, San Diego, CA (US); Marcos de Azambuja Turqueti, El Sobrante, CA (US); Jonathan Allen Kidney, Alexandria, VA (US); Nicholas Edward Wamsley, San Diego, CA (US)

(72) Inventors: Matthew Brett Wrosch, San Diego, CA (US); Marcos de Azambuja Turqueti, El Sobrante, CA (US); Jonathan Allen Kidney, Alexandria, VA (US); Nicholas Edward Wamsley, San Diego, CA (US)

(21) Appl. No.: 14/846,771

(22) Filed: Sep. 5, 2015

Related U.S. Application Data
(60) Provisional application No. 62/077,197, filed on Nov. 8, 2014.

(51) Int. Cl. B01F 11/02

(52) U.S. Cl. CPC B01F 11/0258

(57) ABSTRACT

A system to increase the speed of alcohol fermentation and/or maturation by means of induced waves that can have its frequency and intensity matched to the target application. This system can be deployed using two different architectures. The first is by direct immersion of “self-powered” device into the target medium, which irradiate the fluid, its contents, and its storage container with vibratory and/or sonic energy. These devices can take several forms such as spheres, cubes or any other geometric shape and can be configured with sensors to detect the quality of the medium. Also, the devices can change its buoyancy depending on the conditions of the medium. This change of buoyancy can be utilized to optimize the delivery of vibratory and/or sonic energy to the medium, improve energy transfer from an external power source, or indicate the level of alcohol/content of the medium.

### CROSS-REFERENCE TO RELATED APPLICATION(S)

This application claims the benefit of U.S. provisional Patent Application No. 62/077,197, titled “Oak Barrel Agitation with Wirelessly Powered Devices for Faster Aging in any Sized Barrel,” filed Nov. 8, 2014, the contents of which are hereby incorporated by reference in its entirety.

### FIELD

This invention relates to electromechanically assisted and/or “ultra” sonically assisted acceleration of fermentation and/or maturation. More particularly, it relates to specialized electromechanical devices and systems for mechanical and/or ultrasonic/sonic agitation of fermenting or maturing liquids and stimulation thereof.

### BACKGROUND

Neel et al. (Neel, P., Gedanken, A., Schwarz, R., Sendersky, E., “Mild Sonication Accelerates Ethanol Production by Yeast Fermentation”, Energy & Fuels, 2012, 26, 2352-2356) demonstrated accelerated fermentation time rates by a factor of 2.5 using brewer's yeast (Saccharomyces cerevisiae) when a flask of glucose solution was agitated in a conventional ultrasonic cleaning bath. Matsuura et al. (Matsuura, K., Hirotsune, M., Nunokawa, Y., Satoh, M., Honda, K., Acceleration of Cell Growth and Ester Formation by Ultrasonic Wave Irradiation, Journal of Fermentation and Bioengineering, 1994, 77, 1, 36-40) demonstrated reduced fermentation times by up to 60% for flasks of beer, wine and sake solutions in contact with a piezoelectric element.

These results demonstrate the viability of sonic fermentation, but do so only in a specially controlled laboratory environment. While Tyler, III et al. (U.S. Pat. No. 7,063,867), Dudar et al. (U.S. Pat. No. 4,210,676), and Leonhardt et al. (U.S. Pat. No. 7,220,439) have attempted to extend these principles to commercial applications, the methods/devices of the prior art have not been well adapted by commercial wine/spirits producers due to the clear difficulty of implementation. Accordingly, there has been a long-standing need in the wine and spirits community (as well as other fermentation/aging based industries) for easily implemented ultrasonic/sonic systems for commercial applications. Details of such and other methods and systems are provided in the below description.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, a self-contained, agitation device for agitating sonically a liquid is provided, comprising: an outer, fluid impenetrable closed shell, approximately less than 3 inches in diameter in a horizontal dimension; internal electronics including a power circuit coupled to an internally mounted vibration engine; a multilooped coil internal to the shell, to tap wireless energy and produce power for the power circuit; and at least one of a ballast mechanism and magnet for alignment with an external wireless power transmitter, disposed internal to the shell, wherein the agitation device is adapted for submersion in a liquid within a closed container and is powered by absorbing energy from the wireless transmitter, and wherein an operation of the vibration engine vibrates the shell causing motion of liquid within the container, accelerating interaction of the liquid with the container and/or with elements in the container.

In other aspects of the embodiment disclosed above, the vibration engine is at least one of an unbalanced DC motor, a brushless, unbalanced AC motor, and a transducer; and/or the transducer is an ultrasonic emitter operated within a frequency of 25 kHz to 125 kHz; and/or further comprising an external shell around the closed shell, the external shell having at least one cavity resonant to an operational frequency of the vibration engine; and/or the cavity can operate as at least one of a buoyancy chamber and channeler of flow of external liquid entering the cavity; and/or the cavity channels the flow to provide propulsion; and/or further comprising a communication module to communicate to at least one of a wireless power generating base station and other agitation device; and/or further comprising wireless power generating base station; and/or further comprising a container with a liquid, wherein the agitation device is disposed therein and the base station is disposed adjacent to an exterior of the container; and/or the liquid is a consumable liquid containing alcohol, wherein the liquid is in a pre-consumption state; and/or the container is made of wood; and/or further comprising a battery to power the power vibration engine.

In yet another aspect of the disclosed embodiments, a-contained, agitation device for agitating sonically a liquid is provided, comprising: an outer, fluid impenetrable closed shell, approximately less than 3 inches in diameter in a horizontal dimension; a vibration engine; and a power line coupled to the vibration engine and exiting the closed shell; wherein the agitation device is adapted for submersion in a liquid within a closed container, wherein an operation of the vibration engine vibrates the shell causing motion of liquid within the container, accelerating interaction of the liquid with the container and/or with elements in the container.

In other aspects of the above embodiment, the vibration engine is at least one of an unbalanced DC motor, a brushless, unbalanced AC motor, and a transducer; and/or the transducer is an ultrasonic emitter operated within a frequency of 25 kHz to 125 kHz; and/or further comprising an external shell around the closed shell, the external shell having at least one cavity resonant to an operational frequency of the vibration engine; and/or the liquid is a consumable liquid containing alcohol, wherein the liquid is in a pre-consumption state; and/or the container is made of steel; and/or further comprising an internal battery to power the power vibration engine.

### BRIEF DESCRIPTION OF THE FIGURES

FIG. 1 is a cut-away illustration of one embodiment of an immersion device.

FIG. 2 is a cut-away illustration of another embodiment of an immersion device having an elongated shell, having optional fins.

FIG. 3 is a cut-away illustration of another embodiment of an immersion device, showing a shell with a flush bottom, but with optional fins.

FIG. 4 is an example of a modification of the embodiment of FIG. 1 with externally wired connection(s).

FIG. 5 is a computer-rendering of a sample shell used for an immersion device.

FIG. 6 shows two images of sample wireless immersion devices prototyped for experimentation.

FIG. 7 is an “inside” illustration of a deployed EEE system with multiple immersion devices inside a tank.

FIG. 8 is an illustration of another embodiment, wherein multiple base stations are around a tank.

FIG. 9 is an illustration of a base station having power and communications capability.

FIG. 10 is a cross-sectional illustration of one approach where immersion device is configured with a multi-layer shell.

FIG. 11 illustrates a modification of the design shown in FIG. 10, with multiple cavities.

FIG. 12 illustrates a commercial conical fermenter system with EEE immersion devices interior to the vessel.

FIG. 13 is an illustration of an “internal” transducer system.

FIG. 14 an illustration of another fixed internal transducer system, where transducers are attached interior to a vessel.

FIG. 15 is an illustration of another attachment scheme with the transducer(s) externally mounted to a vessel.

FIG. 16 is a side cut view illustration of a deployment scenario in a barrel.

FIG. 17 is an illustration of a barrel rack configured with induction pads.

FIG. 18 is a multiple view rendering of an EEE system with immersion devices attached to barrels/containers that are placed on a two barrel rack.

FIG. 19 is an illustration of an embodiment including a “cork” mounted immersion device, within a barrel.

### DETAILED DESCRIPTION OF THE FIGURES

The following references, documents, publications are incorporated by reference in their entirety, and are relied upon for their teachings on optimal frequencies and power levels:

Ahman Ziad Sulaiman, “Use of ultrasound in enhancing productivity of biotechniological processes,” Ph.D Thesis for Biochemical Engineering, Massey University, Palmerston North, New Zealand, 2011.

Ahmad Ziad Sulaiman, et al., “Ultasound-assisted fermentation enhances bioethanol productivity,” Biochemical Engineering Journal, Vol. 54 (2011) pp. 141-150.

Kathrin Hielscher, “Ultrasonically-assisted fermentation for Bioethanol Production” Hielscher Ultrasonics, Germany.

Fwu-Ming Shen et al., “The effects of low power level of ultrasonic waves of rice wine maturation,” Journal of Yuanpei University of Science and Technology, No. 10, December 2003, pp. 1-12.

Bucalon A. J., et al., “Bioeffects of ultrasound in yeasts cells suspensions,” RBE. Vol. 7 N.1 1990

Pulidini Indra Neel et al., “Mild sonication accelerates ethanol production by yeast fermentation,’ Energy & Fuels, 2012, 26, 2352-2356.

Tala Yusaf, “Mechanical treatment of microorganisms using ultrasound, shock and shear technology,” Ph.D dissertation. University of Southern Queensland, Australia, 2011.

T. C. James et al., “Transcription profile of brewery yeast under fermentation conditions,” Journal of Applied Microbiology 2003, Vol. 94, pp. 432-448.

For the purposes of explicit disclosure, ultrasonic agitation by other researchers have been successful when using 40 kHz, 30 W/L and 43 kHz, 30 mW/cm², 590 mW/L. Other researchers have shown 20 kHz and 1.6 MHz frequencies to be successful for accelerating the aging characteristics of rice wine. Accelerating the “ripening” alcoholic spirits in wooden barrels has been demonstrated for 20-50 kHz, 1.7 W/l, average ultrasonic intensity of about 0.5 W/cm². Cavitation of wine for accelerated aging has been demonstrated by sweeping high-energy ultrasound 40 kHz-80 kHz.

Other possible successful frequency ranges and power levels and durations are dependent on the medium type, the target material dilution in the medium and objective for ultrasonic agitation, as detailed in the incorporated documents above.

For the purposes of ease of explanation, the term “electromechanical” will be defined herein to generally describe any device or system that performs mechanical work in response to an electrical stimulus, whereas the term “sonic” encompasses the term “ultrasonic” (ultrasonic being a segment of the sonic spectrum), and thereby may be loosely interchangable within this disclosure to describe mechanical displacement that has a vibrational frequency.

To realize the benefits of electromechanical agitation for the acceleration of fermentation or maturation of liquid for aging purposes, at a larger scale, be it for home brewers (for example, 3-20 gallons) up to industrial brewers, vintners and distillers (for example, 20 gallons to >320 gallons), a number of designs are described for imparting electromechanical assisted accelerated fermentation and/or maturation.

The following FIGS. illustrate various possible implementation modes for an electromechanical energy emitter (EEE) system that can be utilized with, for example, glass fermenters (e.g., carboys), wooden body fermenters (e.g., barrels, hogsheads, puncheons) or plastic fermenters/tanks due to the electromagnetic permeability of such containers. In an immersion device configuration of an embodiment of the EEE system, the system can be applied to any container that does not significantly interfere with electromagnetic waves (e.g., plastic, rubber, silicone, fiberglass, etc.). In other embodiments, the EEE system is re-configured to operate within containers known to interfere with electromagnetic waves.

The EEE system increases the speed of cellular growth and multiplication by means of “ultrasonically” generated waves that, in some embodiments, can have its frequency and intensity matched to the target application. The EEE system also increases the maturation of fermented liquids in wooden containers by homogenizing the wood extracts within the maturing medium, thereby continually driving a diffusion gradient at the wood/medium interface while also applying a push/pull action at the interface. By way of implication, this process extends to other containers in which wood alternatives in the forms of chips, spirals, dust, or the like, are utilized for the purposes of imparting wood-based maturation characteristics, or even non-wood based characteristics (e.g., packets of chemicals or organic materials, etc.).

The EEE system can be deployed using different architectures. The first architecture is by direct immersion of “independent,” displaced, self-contained, mechanical energy generating devices in the target medium. The immersion devices irradiate the medium and its holding container with electromechanical energy in the form of mechanical “sound” waves. These immersion devices can take several forms such as spheres, cubes, cylinders or any other geometric shape, the determination of which being based on application preference and design objective. For example, a cube-shaped immersion device will render it less immovable within the medium, while a sphere-shaped immersion device may roll around. While an egg-shape will provide other movement options. Also, in some embodiments, the immersion devices can present negative, neutral or positive buoyancy, or change their buoyancy depending on the conditions of the medium. This change of buoyancy can be active or passive, and can be utilized to optimize the delivery of electromechanical energy to the medium (e.g., move within medium), and/or improve energy transfer from an external power source, and/or indicate the level of alcohol in the medium (e.g., as a specific gravity indicator when the buoyancy is changed).

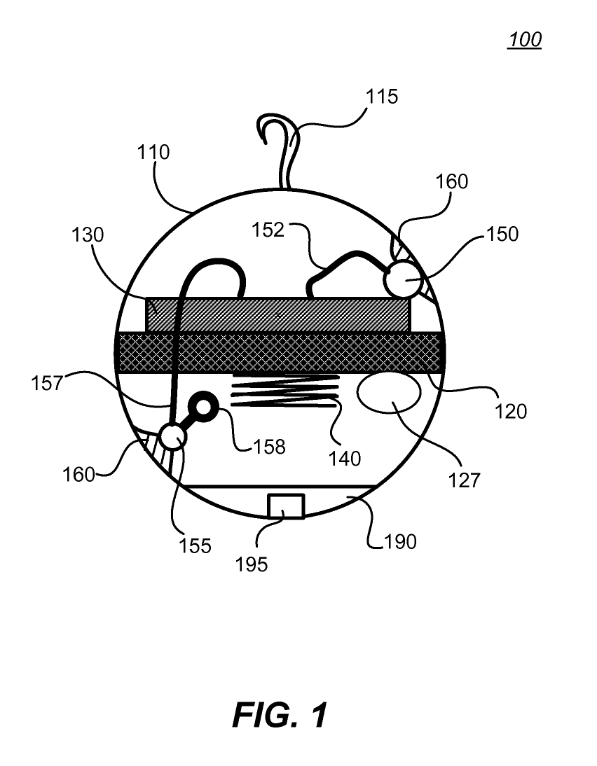

FIG. 1 is a cut-away illustration of one embodiment of an immersion device 100 having a shell 110, having a spherical shape, made of a material that does not interfere with the medium. Examples of non-interfering materials would a biocompatible plastic or metal, being resistant to growth of undesirable biological, for example, food-grade plastics, etc. Other examples could be stainless steel, ceramic, glass, etc. The shell 110 (or housing) could be composed of separate sections which can be made into an integral, medium-impervious (e.g., water tight) with one or more pieces being electromagnetically transparent and optionally, the other piece(s) being metal, if so desired. The “separate” shell pieces of shell 110 may be made integral via welding, gluing, hot adhesion, screw tightening, and so forth. Alternative construction may be for a one-piece shell 110, wherein it is constructed using extrusion, blow molding, injection molding, or casting, etc. Further, while FIG. 1 shows only one “shell,” several layers of shells may be contemplated.

An optional “hook” 115 is shown provided at the top (or any side) of immersion device 100, so as to allow a user to easily retrieve the immersion device 100 within a medium. Of course, in some embodiments, rather than a hook 115 that is externally attached to shell 110, a magnet or even metal section (being responsive to a nearby magnetic “stick”) could be attached to shell 110 to help facilitate the retrieval of the immersion device 100. Of course, it is apparent that alternative methods or mechanisms for “grabbing” the immersion device 100 can be used without departing from the spirit and scope of this disclosure.

Interior to shell 110 is a primary electronics board 120 for the primary modules, non-limiting examples being power and communications electronics, and so forth. Secondary board 130 is provided for housing electronics for the transducer 150 and (optional) sensor 155. Transducer 150 may be directly attached to primary board 120 or displaced from primary board 120, being energized by line 152. The transducer 150 is a electromechanical device that imparts a mechanical vibrational energy, whether periodically or aperiodically. Non-limiting examples are a “cell-phone” vibrator, piezoelectric transducer, mechanical actuator, acoustic resonator, etc.

The transducer 150, when activated, provides the vibrational energy to the shell 110, which is imparted to the liquid or constituent medium that the immersion device is submerged in. Therefore, the immersion device 100 operates (as will be further explained below) as an independent vibrating source within the medium that does not require a physical “access portal” for power. Conventional “vibrating” systems require some access external power via a portal or port, thereby exposing the contents of the container to external gases, bacteria, and contamination. By use of an exemplary system that does not require external “access,” these concerns can be obviated.

Returning to FIG. 1, sensor 155 may be attached or connected via line 157 to primary board 120 or to secondary board 130 (through a via—not shown—in primary board 120). The transducer 150 and/or sensor 155 may be affixed to the shell 110's body via a contacting or bonding material 160. In some embodiments, a coupler (not shown) may be attached to the transducer 150 and/or sensor 155 to facilitate attachment to the shell 110.

While two boards 120, 130 are shown, it is understood that in some embodiments, less boards or more boards may be used, according to design preference. For example, if all of the electronics could be housed only on primary board 120, then secondary board 130 may not be necessary, or vice versus. Accordingly, while this description is in the context of two boards, any number of boards that are suitable can be used.

Also, while FIG. 1 shows primary board 120 being “directly” attached to shell 110 and secondary board 130 “directly” attached to primary board 120, it is expressly understood primary board 120 may be directly attached to secondary board 130, wherein secondary board 130 is attached to shell 110. Accordingly, which board is attached to shell 110 can be left to the discretion of the designer. It is understood however, for purposes of versatility and ease of assembly, primary functions that are shared across different versions/models of immersion device 100 (power being one non-limiting example) would be on what is “termed” the primary board 120, with additional, different functions being achieved via electronics disposed on what is termed the secondary board 130. Of course, this is a matter of preference and not necessity.

In some embodiments, transducer(s) 150 (and/or sensor 155) may be located on primary board 120 due to primary board 120 physical contact with shell 110, resulting in a higher mechanical efficiency of translating the transducer 150 motion to the body of shell 110. Alternatively, the transducer(s) 150 (and/or sensor 155) can be on secondary board 130, but with the transducer 150 in contact with the body of shell 110, resulting in a higher mechanical efficiency of translating the transducer 150 motion to the body of shell 110. Accordingly, output efficiency can be increased by appropriately moving the location of the transducer 150 within shell 110 or by facilitating some means of “contact” 160 between the transducer 150 and the body of shell 110 (e.g., glue, epoxy, gel, etc., that bonds or mechanically communicates energy from the transducer 150 to the body of shell 110). Therefore, the location, orientation, shape of any board or element/device/module inside shell 110 may vary. Thus, modifications, changes that are within the purview of one of ordinary skill in the art may be made without departing from the spirit and scope of this disclosure.

For example, the sensor 155 may

Power module for the boards can comprise induction coil 140 (illustrated here in exaggerated form) that absorbs transmitted energy from an external to the container transmitter (not shown), or a power storage medium 127 (located on primary board 120 or secondary board 130) such as battery, supercapacitor, or both, or other equivalent functioning device. With use of a power storage medium 127, pulsing or other modes of operation can be more easily achieved. Further, if power in the transmitter is temporarily disconnected, the electronics of the immersion device 100 can still function off of the power storage medium 127. The induction coil 140 may be located at the bottom of the shell 110's interior, and may be integrated into board 120, 130. In some embodiments, several induction coils 140 may be situated interior to the shell 110. In other embodiments, the induction coil 140 may be embedded in an “exterior” of the shell 110.

Presuming immersion device 100 is resting on the floor of a container, increased radiation efficiency can be obtained by locating transducer 150 away from the bottom of shell 110, radiating upward through the container. Of course, in some embodiments, it may be desirable to radiate in a different direction and therefore transducer 150 may be so oriented. Further, multiple transducers 150 may be utilized, arranged at different section/angles in shell 110, for different radiating patterns/directions. In more sophisticated embodiments, an array of transducers 150 can be formed to generate beam forming, allowing energy to be steered. In alternative embodiments, transducer 150 can be used for communication, sending, for example, sonic communication signals.

It should be apparent that as transducer(s) 150 are attached to the interior of the shell 110, when the transducer(s) 150 operate, it will vibrate the body of the shell 110. The shell 110 having a larger volume than the transducer(s) 150 will operate to “amplify” the motion of the transducer(s) 150. Accordingly, the entire shell 110 will vibrate in near phase sync with the transducer(s) 150 or out of phase sync (depending on coupling response and other mechanical parameters). In some embodiments it may be desirable to limit the vibration to only a portion of the shell 110, whereas the shell-to-transducer material may be flexible to act as a vibrating membrane, as seen for example in speaker cones and the like. This allows for a better mass-impedance match between the transducer and the shell, allowing for more efficient transmission of energy from the transducer to the outside medium (the flexible shell portion acting as the intermediary). In these membrane embodiments, the vibration will be more directional (as in a speaker) allowing for targeted agitation of the medium. If the transducer is pulsed, then sufficient mechanical force may be exerted by the flexible membrane to cause the immersion device 100 to translate to a desired direction. If there are several membranes disposed about the shell 110, then a form of propulsion using the transducers can be obtained. These and other aspects of transducer manipulation in concert with shell material makeup are contemplated as being within the scope of one of ordinary skill in the art and therefore within the scope of this disclosure.

With respect to communications, instead of utilizing sonic means, alternate communication means, such as a multi-use sensor 155 or induction coil 140 (operating as an antenna) could be used in addition to transducer 150. Further, optical means such as an LED, laser, and/or photo-sensor could be used. The latter example could be used in a medium that is moderately transparent to light (for example, high proof alcohol). For efficiency of transmission, portions of shell 110 adjacent to the communications means 155 would be appropriately transparent to the mechanism of communication. It should be apparent that sensor 155 shown may be replaced with a communications means or, if the sensor 155 is capable of providing communications, operate as a sensor/communication device. Of course, multiple sensor and/or communication devices may be implemented within immersion device 100, according to design preference.

In addition to sonic stimulation, light-based stimulation could also be achieved in immersion device 100 if fitted with a light source, such as an LED. In FIG. 1, a light-based source could take the place of transducer 150, or for a dual-mode immersion device, another section of shell 110 would be dedicated to the light-based source. Steady state illumination or pulsing according to a desired intensity/frequency could be utilized for light energy stimulation. Infrared or ultraviolet light could be generated, not only for stimulation but also for sanitation purposes (recognizing the bacteria killing effect of UV light), or simply to visibly signify an operational status of the immersion device 100.

In some configurations and environments, it may be useful to control the buoyancy of immersion device 100 via an optional buoyancy tank 190. A micro pump (not shown) inside shell 110 would fill or empty buoyancy tank 190 by pumping air in or out. One example of a possible way of implementing this is by attaching the micro pump to an inflatable membrane that alters the surface volume of immersion device 100 or pumps air out/in of shell 110. Any means for affecting buoyancy may be employed.

When primary board 120 is equipped with an induction coil 140 to receive external wirelessly transmitted power, those skilled in the art will recognize that fields between the induction coil 140 and the external field will cause a force. Depending on how the external electromagnetic field is oriented, immersion device 100 can be directed and rotated in this fashion. This can be useful for several purposes such as moving immersion device 100 inside the medium, stirring the medium, and better distributing the mechanical energy irradiated by immersion device 110. In some embodiments, sections of the shell may composed of a material that is magnetically sensitive or magnetized by an external field. Therefore, for retrieval of the immersion device 100 can be more effectively accommodated by “magnetizing” the shell, so as to allow a metal rod inserted into the container to magnetically retrieve the immersion device 100.

In some embodiments, one or more magnet(s) 195 (or ferromagnetic or field sensitive metal) can be positioned within shell 110 for alignment purposes, or. In experimental models, a immersion device 100 was centered to an external energy transmitting coil (not shown) via coupling between the shell's rare earth magnet 195 and a secondary rare earth magnet in the transmitting coil. With “centering,” a higher energy coupling efficiency was achieved between the transmitting coil(s) and the receiving/induction coil 140. In some embodiments, a plurality of magnets (whether rare earth or not) may be used to gauge the amount of coupling efficiency or desire to center (or in some instance, not-center) the immersion device 100 to transmitting coil(s). In other embodiments, a combination of magnets and ferromagnetic/metal elements may be used to assist in drawing the immersion device 100 towards an externally placed (outside the container) power transmitting coil.

As stated above, secondary board 130 can contain several types of sensors 155, depending on the tasked application. Further, sensors 155 may require sampling the external medium, therefore a sample port 158 may be accommodated. Further, in some instances, it may be desirable to introduce a chemical or substance into the medium, originating from the immersion device 100. Thus, sample port 158 can operate as a means for introducing the substance into the medium. Typical sensors 155 (some which require a port to sample the medium) that can be embedded on the secondary board 130 are: temperature sensors, pH sensor, specific gravity, liquid opacity, and so forth. The secondary board 130 can also contain non-medium related devices/sensors such as accelerometers, gyroscopes, GPS, etc. As stated above, one or more of these sensor electronics can be contained on primary board 120, according to design preference.

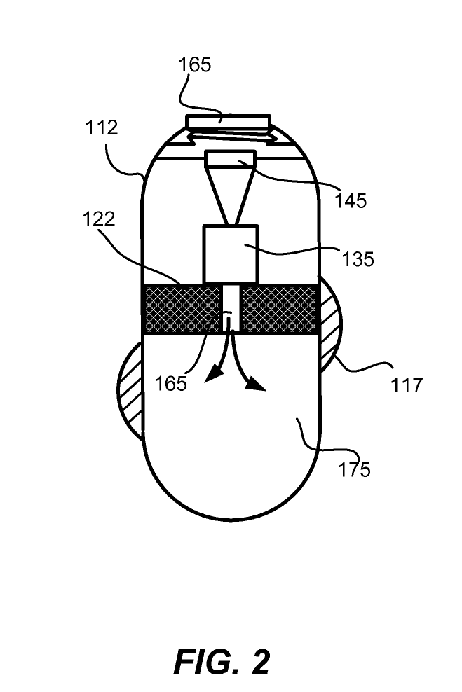

FIG. 2 is a cut-away illustration of another embodiment of an immersion device having an elongated shell 112, having optional “fins” 117. The “fins” 117 provide a non-smooth surface to the shell 112, thus when the transducer (not shown) is vibrating the shell 112, the fins 117 provide additional turbulence generating area to enhance the agitation of the medium. Accordingly, shell 112 may be configured with one or more different attachments/shapes/fins to assist in increasing the agitation capabilities of the immersion device. In it noted that for a “spinning” embodiment, the fins 117 provide a significant increase in effectiveness of medium agitation.

FIG. 2 further illustrates an embodiment with a micro fuel cell 135 used to generate the electricity to run the electronics of primary board 122. In this scenario, power would be obtained via conversion of the microcell fuel into electricity, to run the electronics and transducer (not shown). Filling of the fuel cell can be achieved by an orifice 145 that is penetrated with a fuel containing syringe or applicator, for example, a rubber self-sealing membrane, thus preventing leaking of the fuel into the medium. To further avoid medium contamination, orifice 145 could be further sealable via a primary sealing mechanism 165, for example a screw-on plate or other water proofing seal.

For exhaust gases generated by the fuel cell 135, an opening or channel 165 may be provided to a chamber 175 within shell 112. Typically, but not necessarily, channel 165 may be of a one-way vent allowing the exhaust or waste product gases to vent into chamber 175. If chamber 175 is configured to be of a flexible membrane, then when sufficient gases are vented into chamber 175, it will expand to affect the buoyancy of the immersion device. Therefore, upon a complete cycle of fuel cell use, the chamber 175 can be configured to “bloat” to a degree that will cause the immersion device to float to the surface of the medium. This scenario is particularly effective if the shell 112's lower section is actually replicated by the flexible chamber 175. In some embodiments, chamber 175 may be separable from the shell 112, thus enabling the retained exhaust gases to be dispensed from the immersion device after the immersion device is retrieved from the medium.

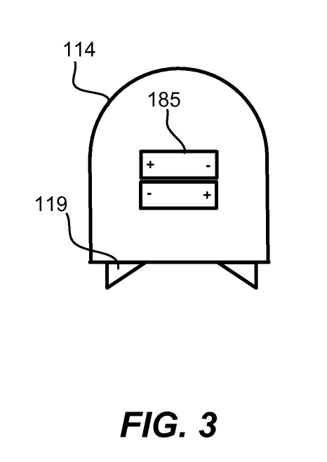

FIG. 3 is a cut-away illustration of another embodiment of an immersion device, showing a shell 114 with a flush bottom, but with optional fin(s) 119 or some form of a shell extension situated on the “bottom” of the immersion device. This embodiment provides a more aggressive means of agitating the contact area between the shell 114 and the vessel's surface (not shown) that the immersion device is placed in. An typical example would be for the case of a spirits cask where the cask's wood, where its intrinsic wood aroma would be more aggressively stimulated via contact through the greater surface area from the shell's bottom fin(s) 119 vibration.

FIG. 3's embodiment also contemplates an embodiment where power is singly or alternatively generated by an internal “battery” 185. The battery 185 may have sufficient energy to power an immersion device for several days or weeks, etc., and therefore externally provided power may not be needed. This would be appropriate for short term fermentation, agitation, aging processes. In these embodiments, the immersion device could be configured as a single use device (for example, disposable after expiration of the battery 185) or be recharged, if so configured. The battery 185 can also act as a backup power source or power well, which allows the immersion device to be powered via external power with the “tapped” power being stored in the battery 185, for future use. Therefore, in some embodiments, if there is an interruption of the transmitted electromagnetic field (for example, maintenance or power failure of base station), then the battery 185 can act as temporary power source to the device's electronics.

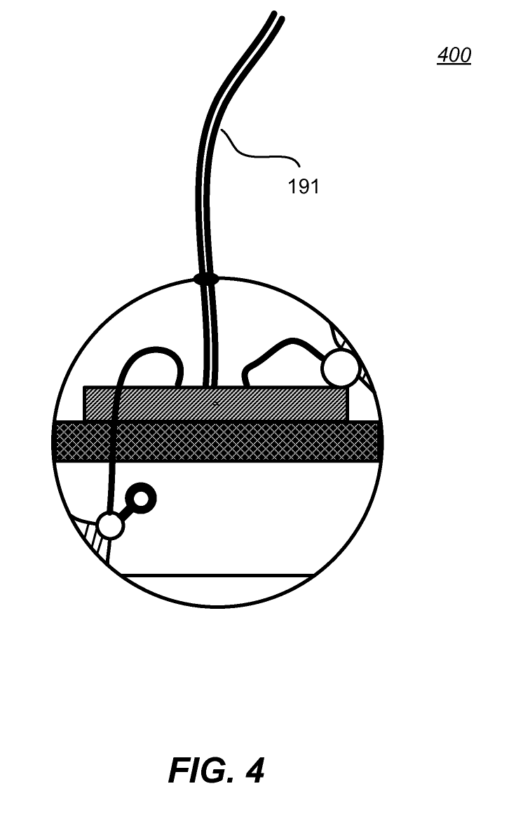

FIG. 4 is an example of a modification 400 of the embodiment of FIG. 1, wherein circumstances dictate that power to the electronics of the immersion device is supplied via an externally wired connection 191. The power source could be a sealed battery or fuel cell placed within the container, or a mains power connected line placed external to the container. As is apparent, the power receiving coils, centering magnet, and optional battery are not needed. This embodiment contemplates a non-wireless system, and is self-explanatory in view of FIG. 1's explanation. For containers that are wooden barrels, using a cork stoppers, the wired connection 191 may be fed through one or more holes that are sealed in the cork.

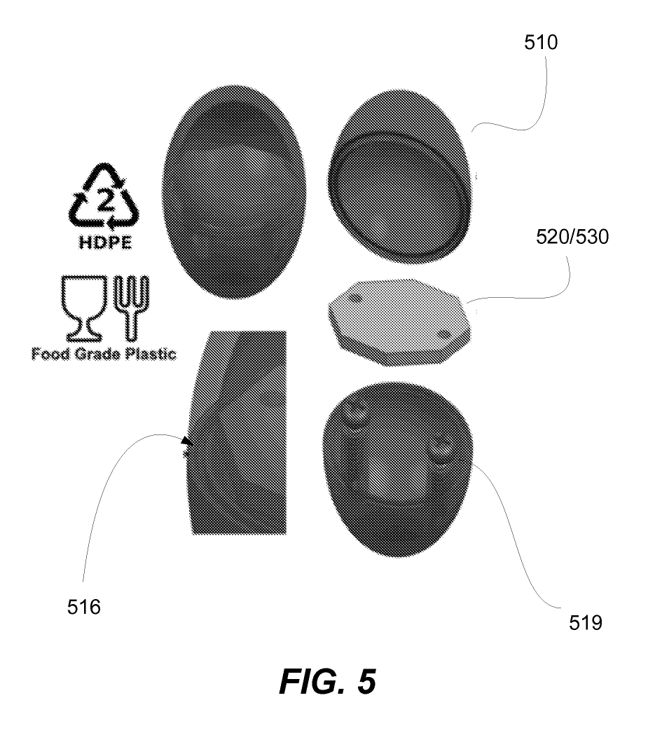

FIG. 5 is a computer-rendering of a sample shell 510 used for an immersion device. The material of the shell 510 is food grade plastic and “welded” together at seam 516. Primary and secondary boards 520, 530 are shown here formed as single board. While this example shows the means of securing the board(s) to the shell 510 via screws 519, it can be via be any suitable means.

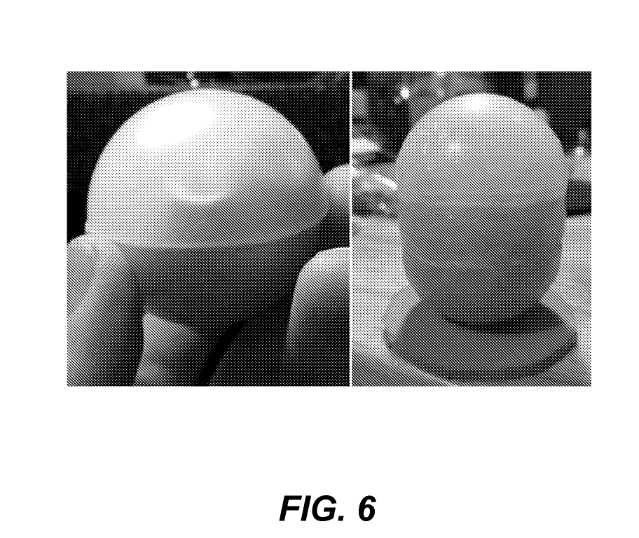

FIG. 6 shows two images of sample wireless immersion devices prototyped for experimentation. The version on the left is spherical, while the version on the right is more prolate, demonstrating that the shapes can be arbitrary, if so desired. It is noted that these immersion devices are sized to fit within wooden casks used by the wine and spirits industry, which typically have 2-3 inch access holes. Of course, other sized holes and attendantly other sized immersion devices are possible. For example, in a wired version or a battery-powered version, the induction coil and associated electronics will not be necessary. Therefore, a smaller immersion device can be fabricated, even down to 1 inch in diameter or less. It is understood that a smaller diameter shell does not necessarily mean a compromise is required of the immersion device, as the shell can be elongated to accommodate a relocation of the necessary components (e.g., wireless), while providing a reduced “footprint.”

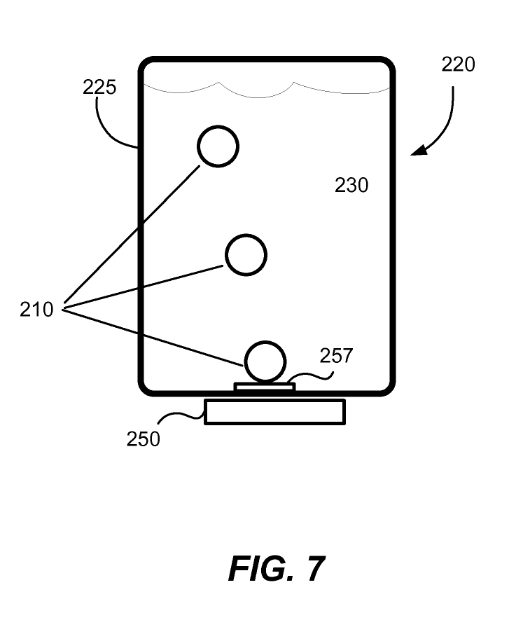

FIG. 7 is an “inside” illustration of a deployed EEE system with multiple immersion devices 210 inside tank 220 made of material 225 that contains a medium 230 being agitated with external base/power generating station 250. The immersion devices 210 inside the tank 220 can be in communication and receiving power from base station 250. Each individual immersion device 210 can be performing a different task. For example, one immersion device can be collecting data regarding specific gravity, while another immersion device is stimulating the medium 230 with mechanical or electrical (for example, photons) energy, and another immersion device is collecting temperature and pH data. This is only one example of the many possible permutations that an EEE-based system is capable. This example presumes that the various immersion devices 210 are not constrained to only the bottom of tank 220. Of course, depending implementation preference, one or more of immersion devices 210 may be suspended within medium 230, or ballast down to the bottom of tank 220, within proximity to base station 250 for efficient energy tapping and/or communication. Or relegated to the bottom of tank 220, if so desired. It should be understood that base station 250 can be placed on the side of tank 220 or at any desired location that allows the immersion devices 220 to receive power.

In some embodiments, the immersion devices 220 can be configured to also communicate between themselves and serve as a relay to transfer information to the base station 250. Assuming that one immersion device 210 wants to send data to the base station 250, it can use a secondary nearby immersion device 210 as a relay. This is advantageous in that it requires less power to transmit data to a nearby relay, and relaying allows the data to be retransmitted farther. In some embodiments, immersion devices 210 can be configured to communicate directly to other devices or external devices such as mobile device or computer using light, RF, sound or ultrasound, depending on its configuration. In some embodiments, one or more of the immersion devices 210 may surface to allow communication.

FIG. 7 also illustrates an object 257 disposed on the bottom of the tank 220. This may be a field-enhancing, passive coil, for example, that redirects energy penetrating into the tank 220 from the base station 250 to the nearest immersion device. The object 257 may also be a pedestal or boundary that constrains immersion device 210 from movement away from the base station 250, being collocated therewith. In another embodiment, object 257 maybe a magnet or other material that attracts the immersion device to its location.

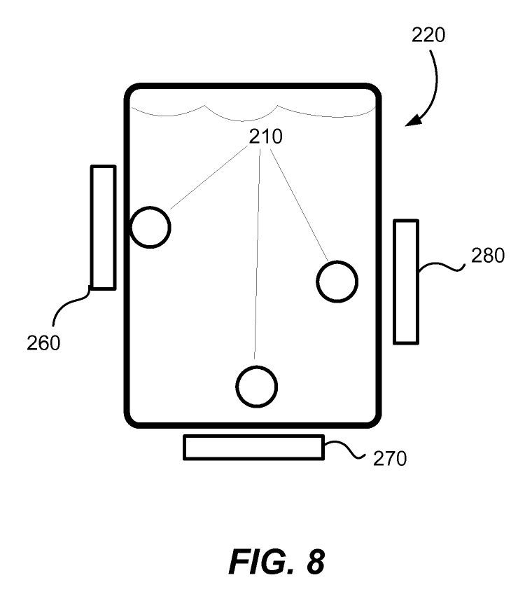

FIG. 8 is an illustration of another embodiment, wherein multiple base stations 260, 270, 280 are around tank 220. They may be “matched” to all the immersion devices 210 in the tank 220 or may be individually matched, for individual immersion device control and powering. As alluded above, the retention of these immersion devices to their respective base stations may be made possible via a magnetic attraction or other means. In some embodiments, the base stations may also be distributed along the bottom of the tank 220, space permitting. Of course, it is apparent that different variations, combinations may be contemplated without departing from the spirit and scope of this disclosure.

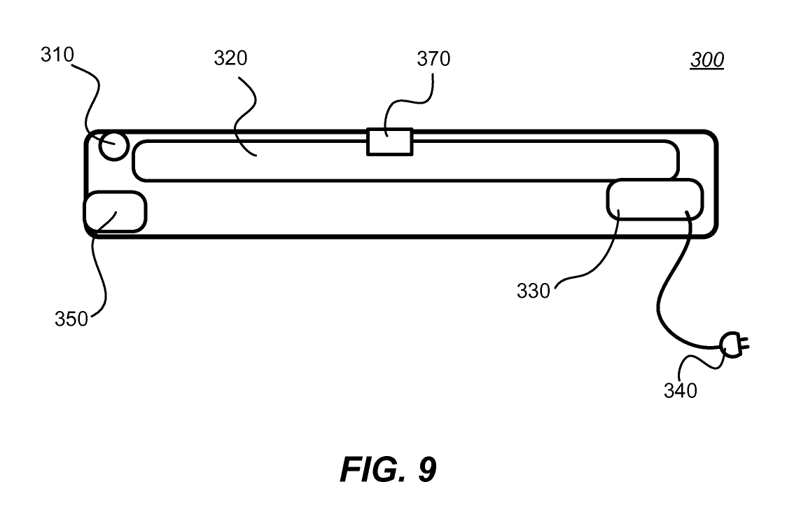

FIG. 9 is an illustration of a base station 300 having power and communications capability for the immersion device(s) (not shown). While it is understood that base station 300 will supply power to the immersion devices to cause agitation of the medium, the base station 300 can also be configured to agitate the medium resting above (in a container) with mechanical (or electrical) energy. This task can be performed by a plurality of transducers and/or actuators 310 distributed along the upper surface of the base station 300, or one or more transducers may be activated for non-homogenous distribution, depending on design preference. If properly sequenced, a series of transducers/actuators can “rock” the container in addition to producing a vibration.

In some embodiments, a combination of agitation via the base station 300 and agitation via the immersion devices may be implemented. Of course, the agitation afforded by base station transducer 310, not being within the medium itself, will be less efficient than an immersion device. The benefit, however, of having a non-immersed agitation source is its power can be provided by a “hard” mains powered line. Further, loss of efficiency can be compensated by using a stronger more robust base station actuator 310.

The base station 300 includes power electronics 330 to convert power from mains line power 340 to the desired frequency and amplitude for transmission coil 320. Mains line power cord 340 can connect directly to an ordinary line (AC) outlet or to a DC power supply, depending on the system configuration.

Communications electronics 350 can be a feature of base station 300, and may have an optional external communication port or be configured with an antenna for wireless communication, or an optical link. Communication can be facilitated via any known or future known system, using any protocol, for example using WiFi, Bluetooth, ZigBee, NFC, USB. Cellular, Fiber, or any other sort of wired or wireless communications that can send and receive information directly or indirectly to a computer or mobile device such as a cell phone or tablet.

This enables base station 300 to communicate externally to commercial devices, but also allows base station 300 a non-acoustic mechanism to communicate to immersion devices within the medium, for example. If linked to the Internet or to a network, the base station 300 can be fully controlled from an external mobile device or computer. Having remote control capabilities allows the immersion devices within the medium to transmit information about the medium or actuate on the medium without the need for an operator to be physically present.

Base station 300 supplies power to the immersion device(s), via the generation of a wireless electromagnetic field which can be tapped by the immersion device(s). To assist centering or aligning the immersion device, magnetic or magnetically sensitive material 370 may be disposed at the top of base station 300. For wireless power transfer, base station 300 contains a transmitting coil 320 to generate an electromagnetic field above (or below) the base station 300. Immersion device(s), sensor device(s) or other devices as described above can thereby tap into the generated electromagnetic field to obtain the needed power. For best transmission of the electromagnetic field, the base station 300 enclosure (specifically the top portion) would be constructed of a non-electromagnetic energy interfering material. The induction coil 320 may be a single coil or multiple coils, depending on design preference. In several experiments, it was discovered that for a given set of constraints (size, number of loops, etc.) multiple coils having a mutual inductance were more effective in generating the desired electromagnetic field energies.

In some embodiments, the coil(s) 320 are displaced from the base station 300 and disposed adjacent to the container under agitation. In these embodiments, the base station 300 provides the “power” for the coil 320 only, via cables (not shown).

For example, in one embodiment, a pair of dual coils can be used for the induction coil 320 and for the induction coil 140 of immersion device 100 (FIG. 1). The individual coils can be in close proximity to each other to maximize the mutual inductance. Analogously, the immersion device's “first” coil is on the base station side/receiving side of the immersion device and the second coil on the electronics side of the immersion device. The dual coils act as highly effective isolation transformers for their respective systems, while helping to transfer power from the base station 300 to the immersion device 100 (FIG. 1) due to a higher Q factor. It is understood that a 1-to-2 coil setup may be used as well as other combinations of coils.

For example, in one experiment using a wirelessly powered configuration, the transmitting coil was approximately 1.97″ in diameter and composed of Type 4 Litz wire, using either 1 layer coil or 2 layer bifilar coils having 10 loops. In this embodiment the transmitter signal was generated by a base station comprising a signal generator connected to an RF amplifier, set as a square wave at approximately 100 kHz+/−25 kHz, and cabled to the transmitting coil. The amplitude of the transmitted signal from the RF amplifier was approximately 20 V-pp. The test base station utilized an AC/DC converter to convert the line current to DC, which was fed to a 555C timer outputting to a 2N6782 transistor pulling a 22 uH transmitting coil. A 1 uF capacitor was series connected between the output of the 555C timer and the transistor, and input biased with 1 k resistors. As should be understood, various modifications and changes may be made to a base station transmitting circuit, by one of ordinary skill in the art and therefore are understood to be within the scope of this disclosure.

The corresponding electronics of the immersion device comprised a single 12.3 uH receiving coil in parallel with a 330 uF capacitor. The receiving coil was a 10 loop, sized as 1.18″ L×1.16″ W×0.03″ H. The output was fed into a rectifying bridge and to a 2,220 uF load capacitor. The output of the load capacitor was fed to 24 mm vibration motor/transducer from Precision Microdrives model 324-401, having a 12 VDC input rating and 140 mA. The motor runs at a rated 5,400 rpm (5.4 kHz), which varies as function of current and amplitude. As should be understood, various modifications and changes may be made to the immersion device's circuitry, by one of ordinary skill in the art and therefore are understood to be within the scope of this disclosure.

In several visual coloration tests, small containers (approximately 1 quart) containing alcohol (ABV 40%-70%) and an approximately a tablespoon charred wood were situated above a base station/transmitter coil. In these tests, the transmitter's RF amplifier's output was connected to the transmitting coil and also a resonant (tank) circuit. To assist in aligning the immersion device to the transmitting coil, a rare earth magnet was placed within the transmitter coil. An immersion device was placed inside the container and power turned on to the transmitter coil. After 24 hours, a clear change in color of the alcohol occurred due to extraction of the charred wood, with the agitated medium visibly darker than the non-agitated control.

It is also worthy to mention that one or more of transducer/actuator(s) 310 can also be replaced with a light source (or a light source added) and therefore perform photo stimulation of the medium in any range of the spectrum including Ultra Violet, Infrared or visible light. This, of course, presumes the medium's container is light-transmissive. It is known that some materials/biological/chemicals, etc. in some media are beneficially responsive to light stimulation and accordingly light stimulation may be facilitated a base station light source. If so configured, base station 300 may optically communicate to/from immersion device(s).

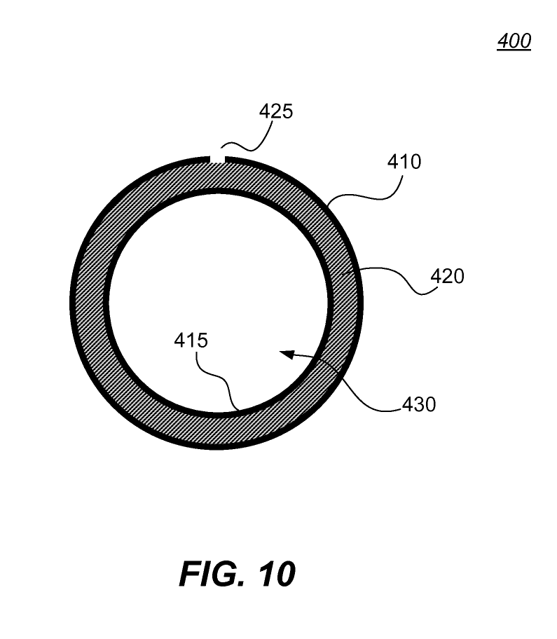

The EEE system can also be deployed using another architecture, where indirect energy transfer is used via resonant principles to increase effectiveness. FIG. 10 is a cross-sectional illustration of one approach where immersion device 400 is configured with a multi-layer shell 410, 415 that forms a resonant cavity 420. Of course, the resonant cavity 420 can be configured to be of another shape, according to design preference. Interior 430 of inner shell 415 would contain the necessary electronics/devices that an immersion device 400 would require, the details of which were discussed in above. Energy from the internal electronics/transducer would transmit into the cavity 420 through inner shell 415, and with appropriate boundary conditions imposed on outer shell 410 and inner shell 415, energy could resonant within resonant cavity 420. Since a resonant cavity can be tuned (by frequency adjustment of the exciting signal) it can multiply and better distribute the electromechanical energy injected in the fluid. If properly tuned, standing waves can form higher intensity wave fronts emanating from immersion device 400.

In some embodiments, the outer shell 410 can have an orifice 425 that can be used for tuning purposes or permit medium liquid to enter/exit resonant cavity 420. In some embodiments, there will be a plurality of orifices 425, provided the resonant cavity characteristics are not too deteriorated by the presence of the additional orifices 425. With the introduction of medium liquid into the resonant cavity 420, one mode of energy “transference” can occur upon the cavity-contained medium liquid. That is, rather than purpose to radiate energy outwardly into the external medium, one possible mode would be to introduce the external medium liquid “into” the resonant cavity 420 and then radiate energy into the cavity contained liquid. Another mode would be to provide dual radiation of energy—externally into the medium and internally into resonant cavity contained liquid.

With an induced flow of medium entering the resonant cavity 420 and exiting the resonant cavity 420, depending on the cavity shape, such a system could act as a pump, pushing medium through the cavity 420. If a plurality of orifices 425 are instituted, then “controlled flow” could be generated. As stated above, the resonant cavity 420 can be of a different shape, configuration, etc. than as shown.

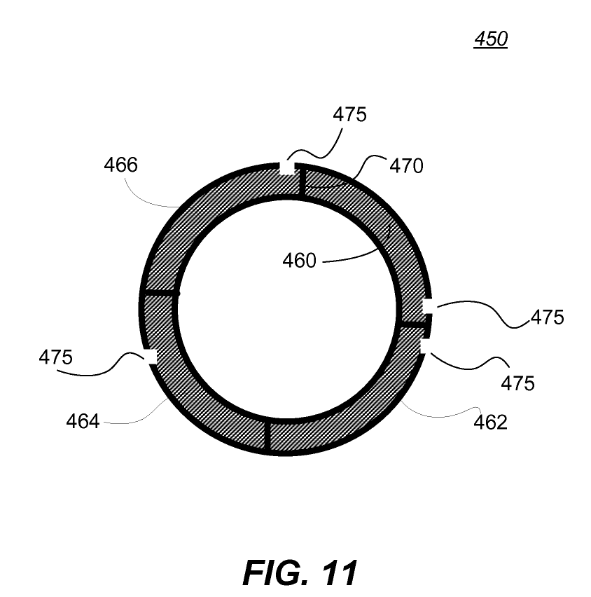

FIG. 11 illustrates a modification of the design shown in FIG. 10, where multiple cavities 460, 462, 464, 466 bounded from each other by barrier 470 are formed with respective orifices 475 in immersion device 470. While only one orifice 475 is shown per cavity, more orifices may be used according to design preference. Similarly, more or less cavities 460, 462, 464, 466 may be used. In some instances, one or more orifices 475 may also be disposed in barrier 470, allowing medium liquid to pass from one cavity to the next. One or more cavities 460, 462, 464, 466 may be at a resonant frequency when liquid is present or when liquid is not present. That is, it is possible to have a non-liquid filled resonant cavity on one side of immersion device 450 and have a liquid filled resonant cavity on the other/neighboring side of immersion device 450. Also, cavities 460, 462, 464, 466 may have different resonant characteristics and may not be symmetric. With different characteristics, the transducer frequencies could be altered allowing one or more cavities to resonant at a given frequency and another one or more cavities to resonant at another given frequency. Thus, some form of directing energy can be accommodated.

It is fully contemplated that with appropriate shaping and design of the orifices 475 with cavities, the immersion device 450 could take advantage of the resulting resonant “pumping” action to generate propulsion. That is, as flow is being generated, it could be asymmetrically generated to cause the immersion device 450 to move, rotate, etc. With frequency modulation or shifting of the transducer frequency, movement could be controlled. It is fully contemplated that one or more resonant cavities could be configured to expel medium, at a given frequency, so as to increase the buoyancy of the immersion device 450 to cause it to rise to the surface of the medium. Though not expressly shown here, the immersion devices may be configured with a ballasting system as earlier described. Or, alternatively, one or more of the resonant cavities described above may be configured as a ballast system. For example, at a particular frequency, the designated resonant cavity may “bulge” or expand (presuming it is of an expandable material), so as to cause the immersion device to increase its buoyancy. Alternatively, the cavity may shrink, to reduce the immersion device's buoyancy. One or more cavities may be evacuated of any fluid, causing air to form in the cavity and produce ballast.

It is understood, given the disclosure provided above, that changes and modifications may be made to various shapes, configurations and so forth to the above systems without departing from the spirit and scope of this disclosure. For example, the cavities may be multi-shaped, multi-chambered, etc.

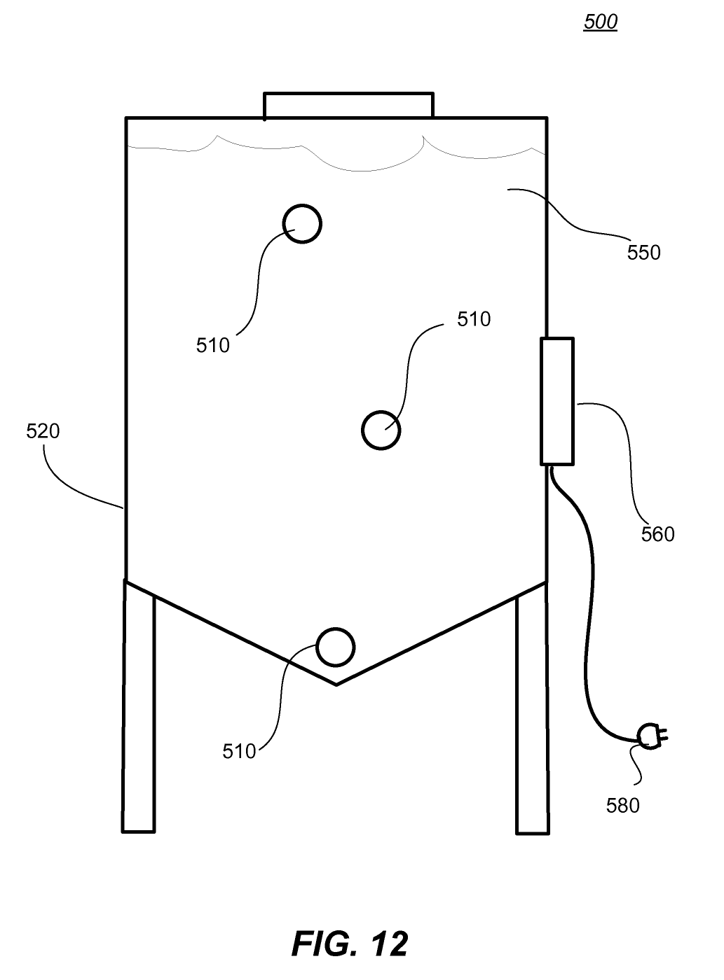

In addition to electromechanical stimulation of a medium via an EEE system, a hybrid system is contemplated where an internal EEE system can be utilized with an external transducer system. FIGS. 12-15 provide examples of alternative schemes for imparting agitation, for example, to an “industrial” conical-shaped fermenter, the primary fermentation vessel used in industrial brewing and/or fermenting. Of course, other shaped fermenter or medium containing vessels may be used.

FIG. 12 illustrates a commercial conical fermenter system 500 with EEE immersion devices 510 interior to the vessel 520 and in medium liquid 550. It should be noted that while the term liquid is used throughout this disclosure to describe the medium being affected by the EEE systems, the medium may be of a semi-liquid form or aggregate nature, and so forth. Thus, the term liquid should be interpreted as generally as possible, as the exemplary systems provided herein may be applicable to medium that has a high viscosity, than what is typically considered a liquid. For example, yogurt, chemical slurries, etc. may constitute the medium being affected.

External (non-immersive) transducer 530 is attached to the vessel's 520 outer surface and controlled by power source/signal generator 560 having external power connection 580. Such a system 500 could provide micro and macro agitation, where depending on power capabilities the EEE immersion devices 510 could target the “deep” interior portions of the vessel 520 while the external transducer 560 could target the outer portions of the vessel 520. With different transducer systems, different frequency and/or agitation profiles could be generated and exploited.

Further, EEE immersion devices 510 could also be set to a frequency of resonance that is coincident with external transducer 560. That is, external transducer 560 could be the source of resonant frequency energy for a resonant cavity EEE immersion device 510, rather than the immersion device 510 itself. In this manner, not only could external transducer 560 cause EEE immersion device 510 resonance “flow” from mechanical energy arriving from external transducer 560, it is contemplated that a buoyancy condition for the immersion device 510 could be based on external transducer 560. For the latter case, the external transducer 560 frequency could be set to trigger one or more immersion devices 510 to change their buoyancy. Such a design would fish up all (or only a designated one) immersion devices 510, including dead ones that could not on their own alter their buoyancy (for example, due to loss of internal power). Similar to controlling buoyancy, movement in a lateral or vertical plane could also be effected.

While FIG. 12 illustrates one transducer 560, multiple transducers may be placed on the exterior of vessel 520. Also, understanding resonance principles, it may be possible to tune the transducer 560 to operate in a resonant frequency with respect to vessel 520—that is, the vessel 520 constitutes a cavity that when appropriately stimulated can act as a resonant cavity, thereby producing standing waves or increased agitation.

Also, while FIG. 12 describes element 560 as a transducer, it is understood that element 560 may also operate as a base station, providing power and/or communications to immersion devices 510. If vessel 520 is constructed of a conductive material so as to deter the penetration of electromagnetic fields, it is possible for transducer/base station 560 to provide sonic “power” to the interior of vessel 520, wherein immersion devices 510 may be configured with resonant cavities that have power tapping capabilities. That is, the resonant cavity in an immersion device 510 may be designed to have a piezoelectric or other mechanical-to-electrical conversion capability, such that as mechanical energy is being trapped and resonated within immersion device 510, the mechanical motion can be translated to electrical energy. This electrical energy can be converted by internal electronics to power immersion device 510. In some instances, the tapped energy may be sufficient to operate the electronics within immersion device 510 such as sensors, or even to power a transducer within immersion device 510.

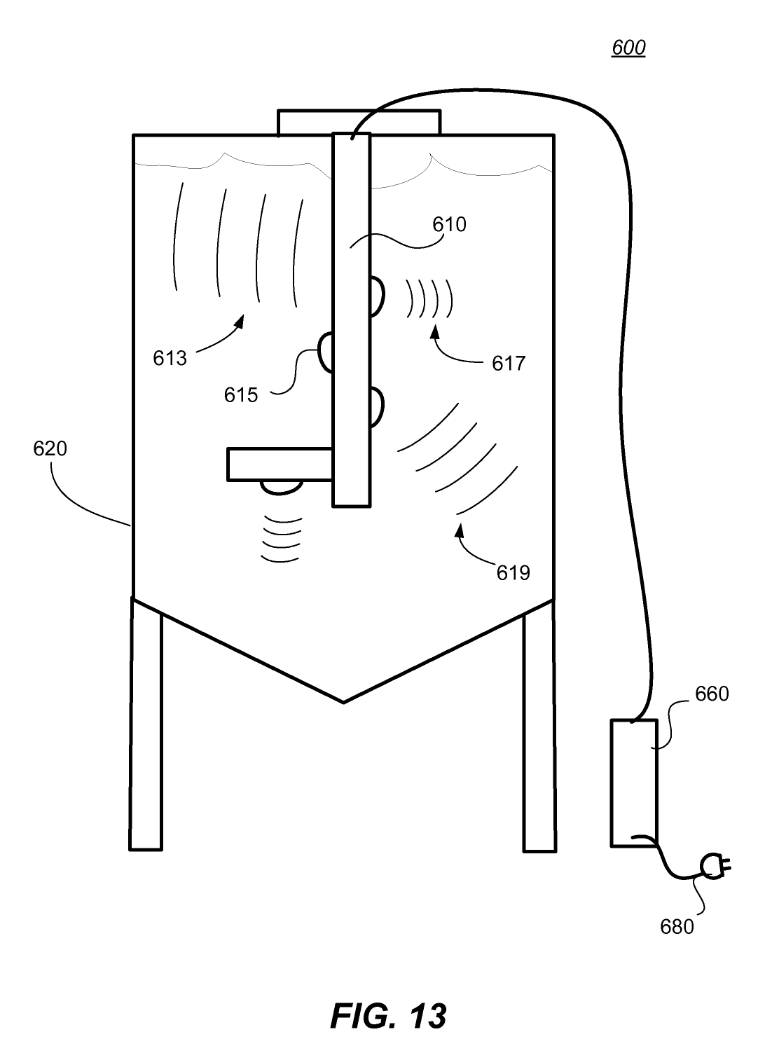

FIG. 13 is an illustration of an “internal” transducer system 600. Rather than use remote immersion devices, this embodiment contemplates a “hard-wired” transducer rod 610, which is placed inside vessel 620 and connected to power source/signal generator 660 having line power 680. Having a hard-wired system bypasses the energy coupling requirements with remote immersion devices. Several variations or modes of operations are possible. In one embodiment, transducer rod 610 vibrates to provide agitation waves 613 in the vessel 620. In another embodiment, the transducer rod 610 can vibrate but also be supplemented with individual (or arrays) transducer elements 615 disposed along transducer rod 610, which also vibrate to form agitation waves 617. Therefore, the system of FIG. 13, having multiple transducers 610, 615 can allow more surface area to be targeted. Also, with multiple transducers, a phasing can be generated to cause “beam forming” of the electromechanical energy. With beam forming (analogous to phased array radars), the energy can sweep the vessel 620, in effect mechanically stirring the medium. Based on how the phasing of the transducers 615 are set, a particular section of the vessel 620 can be targeted for a predetermined period time, if so desired. Such a system would obviate the need for actual physical mechanical stirrers, relying on the phasing to accomplish the same or nearly the same effect. Power source/signal generator 660 would require multiple outputs for phasing, with the actual phase delay occurring from power source/signal generator 660 or being implemented by a phase delay network between power source/signal generator 660 and transducers 615. In one embodiment, the transducer rod 610 is not a transducer but a support pole for transducers 615, the transducers 615 generating the agitation energy in the vessel 620.

For large systems, a single transducer system 600 may prove to be easier to manage and if provided with enough surface area/depth and power, effective fermentation/activation of the medium can occur. The above system contemplates that there will be a large opening at the top of vessel 620 (which typically is) so entry to the vessel 620 can be easily accommodated for. Equivalently, any port with access to the interior of the vessel 620 could be utilized with appropriate means for sealing the port designed into the embodiment. While the term “rod” has been used, it is understood that any shape may be used, as evident in the branch shown FIG. 13.

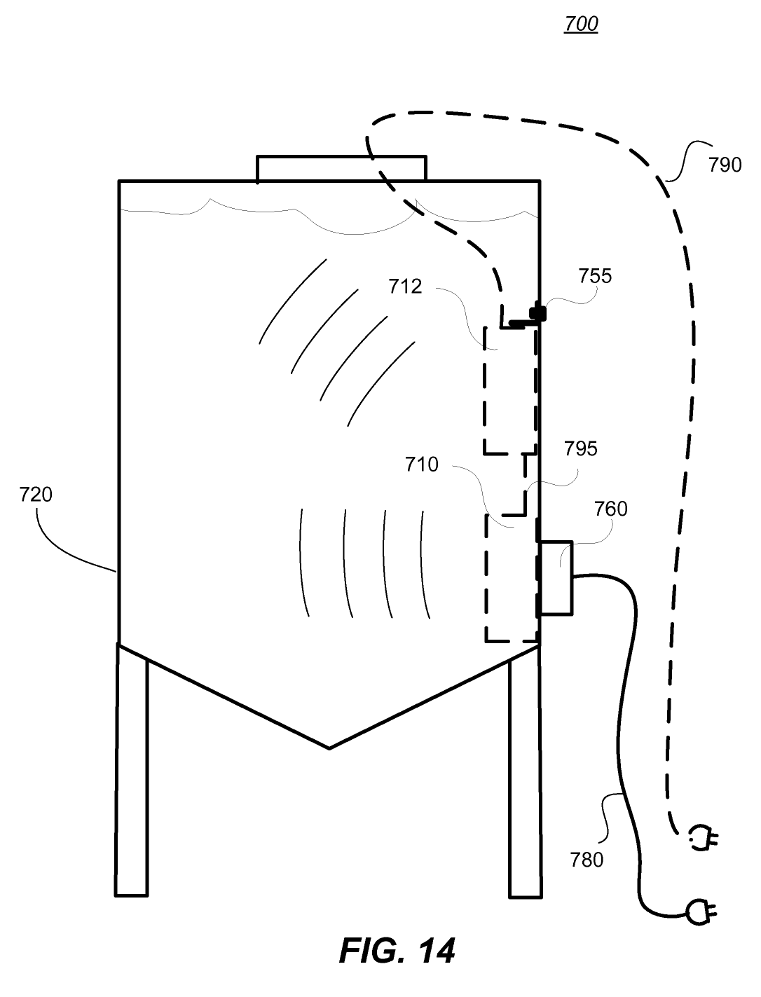

FIG. 14 an illustration of another fixed internal transducer system, where transducers 710, 712 are attached interior to vessel 720. This design differs in that the transducer 710, 712 are situated to the side of vessel 720 rather than from the top. Transducer 710 is magnetically or inductively attached to the vessel 720 wall, or via any mechanism that does not affect the integrity of the vessel 720's wall. In some embodiments, where the vessel 720 is non-metal (or portions thereof), an inductive means can be used to directly transfer energy/power to the transducer 710. For example, energy to transducer 710 can be conveyed via transmitter 760, which is powered via line power 780.

Transducer 712 is shown as an alternative mounting procedure and powering mechanism. Specifically, transducer 712 is “attached” to an internal mount 755 that is affixed to the wall (or side) of vessel 720. This approach presumes mount 755 breaches the wall of vessel 720, but is done in a manner that does not compromise the vessel's integrity. Also, powering of transducer 712 can be though a direct line 790 which is fed through a port or opening in vessel 720. Alternatively, transducer 712 may be powered via a direct connection 795 from neighboring transducer 710, or vice versus. As is apparent, multiple transducers may be internally positioned within vessel 720 and as such, beam forming can be achieved through proper phasing.

The vessel 720 can also act as a resonant cavity and therefore appropriate positioning of transducer(s) 710, 715 4 can result in resonance occurring or not occurring. In some instances, it may be desirable to place the transducer(s) 710, 715 near the bottom of vessel 720. In other instances, it may be desirable to have a plurality of transducers arranged on the sides and/or bottom and/or top.

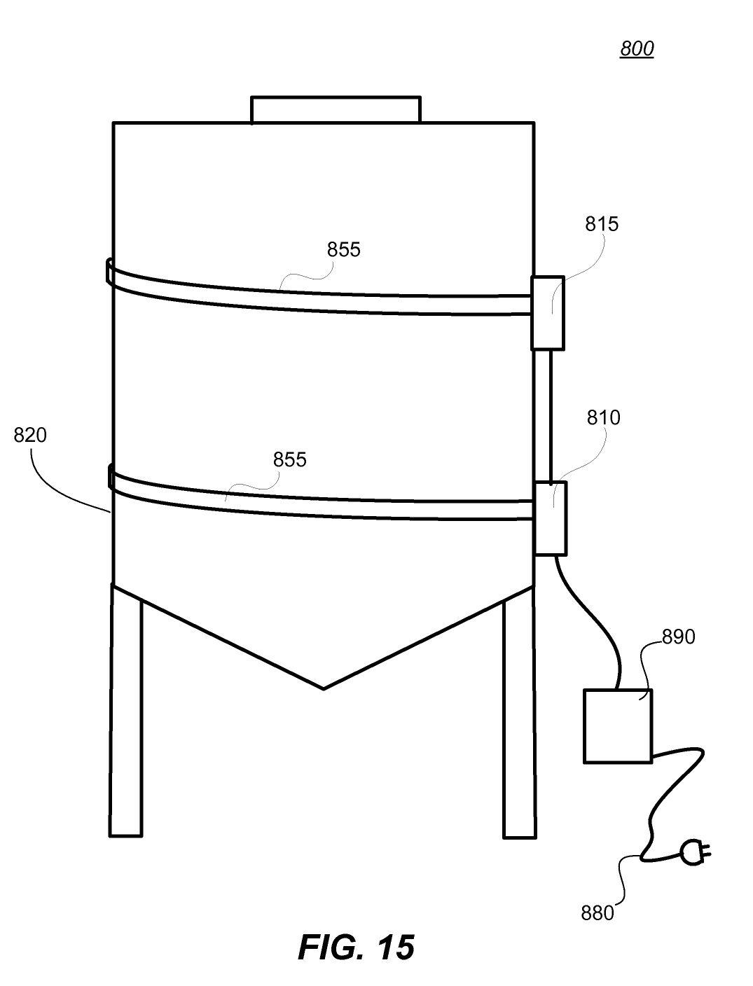

FIG. 15 is an illustration of another attachment scheme with the transducer(s) 810, 815 externally mounted to vessel 820 via a “belt” 855 or similar attachment mechanism. This embodiment does not violate the integrity of the vessel 820's structure, relying on the belt 855 for easy attachment. Transducers 810 815, being external can be configured with optional means for local temperature control, one possible non-limiting example being a Peltier cooler. The external system 800 is connected to power supply/signal generator 890 via line 880.

It should be noted that each of the signal generators and/or related transducers in any one of the above embodiments, may be configured to “communicate” to each other or to another device. For example, a transducer may be equipped with sensor/measurement capabilities to determine the temperature, specific gravity, acidity/alkalinity of the medium and relate that information to an external system/computer. The external system may be attached to the transducer or to the signal generator, or may be communicated to via a wireless connection. Accordingly, operation of the system can be managed remotely as well as monitoring the performance thereof.

It should also be noted that various EEE immersion devices may be used in combination with these “large” transducer systems of FIGS. 12-15, according to design preference. For vessels that are made of materials that do not interfere with wireless power transfer, an EEE immersion base station can be placed on the exterior of the vessel. In some embodiments, the large transducer system may have a wireless power supplying capability co-located with the “internal” transducer. Thus, the internal transducer can also act as a charge supplying source for the EEE immersion devices. In other embodiments, the large transducer system may have communications capability co-located with the “internal” transducer. Thus, the internal transducer can also act as a communications conduit for the EEE immersion devices.

Accordingly, it is contemplated that one of ordinary skill could deploy a system of EEE immersion devices with sensor only capabilities, wherein the sensor data is communicated to the communications-capable internal transducer. The internal large transducer would provide the desired electromechanical agitation effect, while the EEE sensors would provide measurement data, which would be forwarded by the internal large transducer to the appropriate external computer.

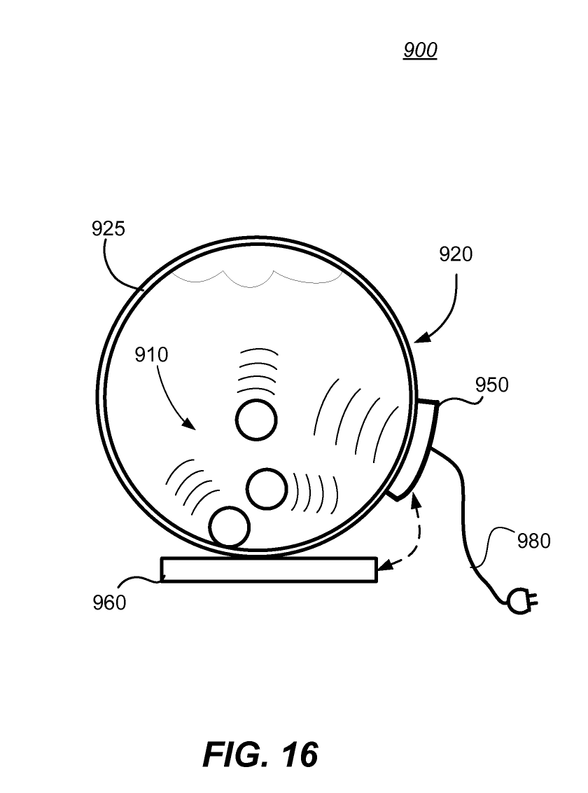

FIG. 16 is a side cut view illustration 900 of a deployment scenario in a barrel 920 constructed of wood 925 containing any one of beer, wine or spirits, etc. EEE immersion devices 910 could be deployed with buoyancies that distribute their locations at different levels/depths within barrel 920. Base station 960 could be placed at the bottom of barrel 920. The size of the EEE immersion devices 910 could be small enough to be inserted through the barrel's bunghole which is approximately 2 inches in diameter for some industries. The inserted EEE immersion devices 910 could be allowed to reside either within the aging/maturing medium—on the bottom of the barrel 920, or floating on the top depending on the buoyancy characteristics of interest and where the greatest performance gains are. To supplement the immersion devices 910, an external larger transducer 950 can be attached to the barrel 920 or to a barrel support (not shown) which is line powered 980. In some embodiments, immersion devices 910 may simply operate as sensors wherein agitation is solely provided by external transducer 950. In these embodiments, a form of tuning can be accomplished to obtain increased efficiency. For example, immersion devices 910 (either as a sensor alone or a combination transducer/sensor) can detect the amplitude of vibration actually inside a portion of the barrel 920 and particularly at a “position” within the barrel. This detection can be used as feedback to base station 960 which can then either signal to the user the actual magnitude/frequency being measured in the liquid or adjust external transducer 950 to the desired magnitude/frequency. In some embodiments, the immersion device 910 may send movement within the barrel 920, indicating the degree of vibration. For example, presuming resonance is desired in the barrel 920, which would result in large “waves” of the medium, the immersion device 910 could “report” that a periodic large displacement of its position is occurring, indicating wave action.

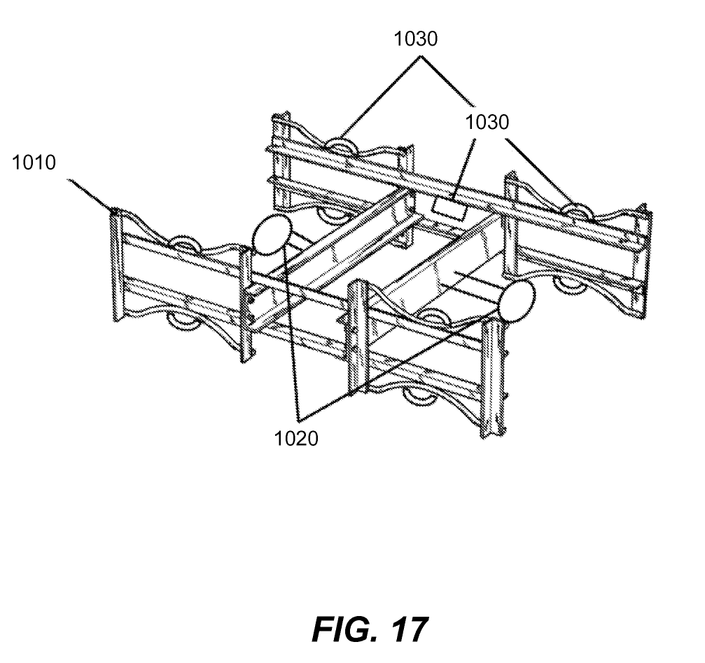

FIG. 17 is an illustration of a barrel rack 1010 configured with induction/field generating pads (base station) 1020 for use with an EEE system. Induction pad 1020 can also be configured with additional light source functions and photosensors for communication and/or excitation of the medium (possible with a light transparent barrel). The barrel rack 1010 is shown as a two-barrel configuration, but it is understood that additional barrel configurations can be added by replicating the described structure.

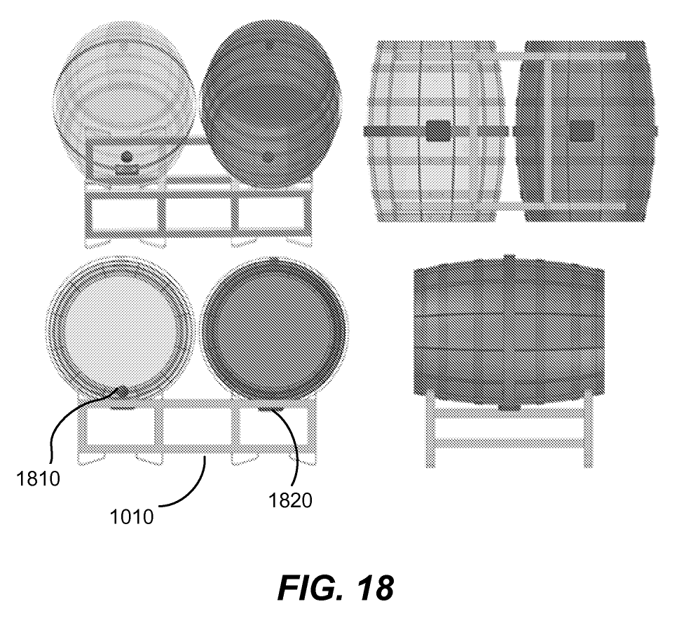

FIG. 18 is a multiple view rendering of an EEE system with immersion devices 1810 attached to barrels/containers that are placed on a two barrel rack 1010. The transmitter array 1820 is “strapped” to the barrels, providing power/signals to the immersion devices 1810 disposed inside the barrels. Details of this operation are self-evident from the above discussions.

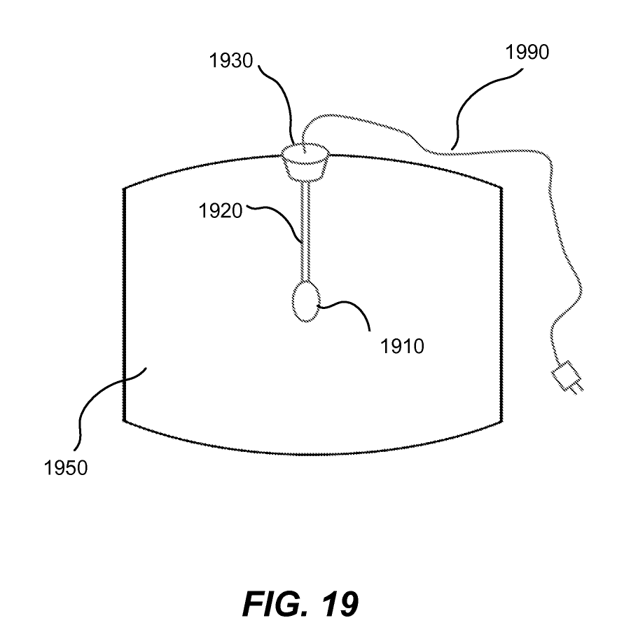

FIG. 19 is an illustration 1900 of an embodiment including a “cork” mounted 1930 immersion device 1910, within a barrel 1950. This embodiment is a combination of various earlier embodiments, showing immersion device(s)—more than one can be connected—being held in place by non-or-flexible arm 1920 which has power and/or signal lines which exit cork 1930 and connect externally 1990 to power-supplying and/or signal supplying/processing sources (not shown). This solution provides a simpler solution, since a harness of wires can be fed to different barrels, via a single power/signal power source, and wireless power support is not needed.

Various embodiments described above may be applied to beer fermentation, alcohol/spirits aging, wine aging, yogurt, kombucha, chemical reactors, and other “processes” where fermentation, aging and/or agitation is required of the target medium.

It should be understood that while the various examples shown above are in the context of fluids containing alcohol, such as beer, wine, spirits, etc., the systems and methods described can be used for non-alcohol based mediums, where a mechanical form of agitation is desired but without the use of “physical” large object stirrers or paddles, which may crush the medium components. For example, chemical tanks can be “stirred” by the systems and methods described herein. Furthermore, medical solutions that need agitation could similarly benefit from these systems/methods. Biological solutions could have their growth/reaction times reduced by the stimulation of the growth medium.

As can be appreciated, various different deployment schemes and applications are made possible via the flexibility of the systems and capabilities described. Therefore, it understood that many additional changes in the details, materials, steps and arrangement of parts, which have been herein described and illustrated to explain the nature of the invention, may be made by those skilled in the art. And that such alterations are within the principle and scope of the invention as expressed in the appended claims.

What is claimed is:

1. A self-contained, agitation device for agitating sonically a liquid, comprising:
an outer, fluid impenetrable closed shell, approximately less than 3 inches in diameter in a horizontal dimension;
internal electronics including a power circuit coupled to an internally mounted vibration engine;
a multilooped coil internal to the shell, to tap wireless energy and produce power for the power circuit; and
at least one of a ballast mechanism and magnet for alignment with an external wireless power transmitter, disposed internal to the shell,
wherein the agitation device is adapted for submersion in a liquid within a closed container and is powered by absorbing energy from the wireless transmitter, and wherein an operation of the vibration engine vibrates the shell causing motion of liquid within the container, accelerating interaction of the liquid with the container and/or with elements in the container.

2. The device of claim 1, wherein the vibration engine is at least one of an unbalanced DC motor, a brushless, unbalanced AC motor, and a transducer.

3. The device of claim 2, wherein the transducer is an ultrasonic emitter operated within a frequency of 25 kHz to 125 kHz.

4. The device of claim 1, further comprising an external shell around the closed shell, the external shell having at least one cavity resonant to an operational frequency of the vibration engine.

5. The device of claim 4, wherein the cavity can operate as at least one of a buoyancy chamber and channeler of flow of external liquid entering the cavity.

6. The device of claim 5, wherein the cavity channels the flow to provide propulsion.

7. The device of claim 1, further comprising a communication module to communicate to at least one of a wireless power generating base station and other agitation device.

8. The device of claim 1, further comprising wireless power generating base station.

9. The device of claim 8, further comprising a container with a liquid, wherein the agitation device is disposed therein and the base station is disposed adjacent to an exterior of the container.

10. The device of claim 9, wherein the liquid is a consumable liquid containing alcohol, wherein the liquid is in a pre-consumption state.

11. The device of claim 10, wherein the container is made of wood.

12. The device of claim 1, further comprising a battery to power the power vibration engine.

13. A self-contained, agitation device for agitating sonically a liquid, comprising:
an outer, fluid impenetrable closed shell, approximately less than 3 inches in diameter in a horizontal dimension;
a vibration engine; and
a power line coupled to the vibration engine and exiting the closed shell;
wherein the agitation device is adapted for submersion in a liquid within a closed container,
wherein an operation of the vibration engine vibrates the shell causing motion of liquid within the container, accelerating interaction of the liquid with the container and/or with elements in the container.

14. The device of claim 13, wherein the vibration engine is at least one of an unbalanced DC motor, a brushless, unbalanced AC motor, and a transducer.

15. The device of claim 14, wherein the transducer is an ultrasonic emitter operated within a frequency of 25 kHz to 125 kHz.

16. The device of claim 13, further comprising an external shell around the closed shell, the external shell having at least one cavity resonant to an operational frequency of the vibration engine.

17. The device of claim 13, wherein the liquid is a consumable liquid containing alcohol, wherein the liquid is in a pre-consumption state.

18. The device of claim 13, wherein the container is made of steel.

19. The device of claim 13, further comprising an internal battery to power the power vibration engine.
